(19) United States
(12) Patent Application Publication
(10) Pub. No.: US 2008/0061528 A1
(43) Pub. Date: Mar. 13, 2008

(54) Foldable bicycle frame

(76) Inventor: Yaniv Musabi, Givaataim (IL)

Correspondence Address: PEARL COHEN ZEDEK LATZER, LLP, 1500 BROADWAY 12TH FLOOR, NEW YORK, NY, 10036, US

(21) Appl. No.: 11/826,536

(22) Filed: Jul. 16, 2007

(30) Foreign Application Priority Data
Jul. 16, 2006 (IL) 176887

(51) Int. Cl. B62K 15/00

(52) U.S. Cl. 280/287

(57) ABSTRACT

A foldable bicycle frame comprising a steering part comprising a first bar provided with at least one ring at a first end of the bar and a handlebar stem pivotally connected to the first bar at a second end for coupling to a front wheel; a seat support part comprising a second bar provided with at least one ring at a first end of the bar and a adapted to be coupled to a seat at a second end; a rear paddling part comprising a third bar provided with at least one ring at a first end of the bar and a adapted to be coupled to rear wheel; a tubular cylinder connecting unit about which the rings of the first, second and third bars are pivotally mounted, wherein the rings may be aligned and fixed in at least one alignment.

### CROSS REFERENCE TO RELATED APPLICATIONS

This application claims priority from Israeli Patent Application Number 176887, filed on Jul. 16, 2006, which is incorporated in its entirety herein by reference.

### FIELD OF THE INVENTION

The present invention relates generally to an improved bicycle structure and, more particularly, to an improved foldable bicycle structure.

### BACKGROUND OF THE INVENTION

For transporting on public transportation facilities or in a private car, a foldable bicycle is considerably more convenient than the standard, rigid frame, bicycle. Much thought and creativity have been devoted over the years to how to fold a bicycle in the most compact manner while maintaining the stability, and riding-convenience of a standard non-folding bicycle.

For substantially reducing the bulkiness of a bicycle frame four main categories of folding have been developed:

1) Various ways and means of disassembly and quick reconstruction of the frame to and from basic components;

2) The folding of the frame in two, suggesting a “closed book” approach, as demonstrated in U.S. Pat. No. 6,116,629 and U.S. Pat. No. 6,135,478;

3) The compaction of the frame using hinges, suggesting “a closed accordion”, as demonstrated in U.S. Pat. No. 6,883,817 and U.S. Pat. No. 6,986,522; and

4) The pivoting of the main elements of the bicycle around a central hinge, suggesting a “closed pen-knife” approach, as demonstrated in web-site: http://design.runride.com/design/mipis/lybm30dbfa.asp?Page=2&key=winner2005&sto re=design&frecno=18.

In some cases two of the categories have been merged, as demonstrated in U.S. Pat. No. 6,267,401.

The “pen-knife” folding manner has the advantages of eliminating the possibility of loss of elements and parts that must to be stored, enables a tighter compaction than the “closed book” folding and since it is based on only one central hinge reduces the probability of mechanical failure in the course of use in comparison to elaborate mechanical “closed accordion” folding configurations.

The “pen-knife” folding bicycle demonstrated in http://design.runride.com/design/mipis/lybm30dbfa.asp?Page=2&key=winner2005&sto re=design&frecno=18 is constructed of two main parts: a frontal wheel steering part and a seat and back-wheel driving part. Both parts pivot around a hollow tube shaped cylinder axis with no freedom to adjust and change the relative connection between the parts to accommodate to various different desired configurations when the bicycle frame is opened.

In the present invention the folding of the bicycle is manifested by pivoting three main and separate parts around a hollow tube-shaped cylinder axis: a frontal wheel steering part, a seat-part and a back-wheel paddling part. The configuration of the three-hinged parts provides for a superior, easy to fold and assemble bicycle frame that can be adjusted to various riding conditions and to the riding comfort of various people.

### SUMMARY OF THE INVENTION

There is thus provided, in accordance with some preferred embodiments of the present invention, a foldable bicycle frame comprising: a steering part comprising a first bar provided with at least one ring at a first end of the bar and a handlebar stem pivotally connected to the first bar at a second end for coupling to a front wheel; a seat support part comprising a second bar provided with at least one ring at a first end of the bar and a adapted to be coupled to a seat at a second end; a rear paddling part comprising a third bar provided with at least one ring at a first end of the bar and a adapted to be coupled to rear wheel; and a tubular cylinder connecting unit about which the rings of the first, second and third bars are pivotally mounted, wherein the rings may be aligned and fixed in at least one alignment.

Furthermore, in accordance to some preferred embodiments of the present invention, at least one bore is provided on each ring and a matching peg is provided to be inserted in the bore in order to fix the rings in a predetermined alignment.

Furthermore, in accordance to some preferred embodiments of the present invention, said at least one ring of each of the bars comprises a pair of rings.

Furthermore, in accordance to some preferred embodiments of the present invention, at least one shock absorber is further provided to the rear paddling part.

### BRIEF DESCRIPTION OF THE DRAWINGS

In order to better understand the present invention, and appreciate its practical applications, the following Figures are provided and referenced hereafter. It should be noted that the Figures are given as examples only and in no way limit the scope of the invention. Like components are denoted by like reference numerals.

FIG. 1 is schematic view of a foldable bicycle according to a preferred embodiment of the present invention, in a riding assembled configuration;

FIG. 2 is a view of the bicycle shown in FIG. 1 in a riding assembled configuration with the wheels removed;

FIG. 3A is a schematic view of the frontal steering part of the foldable bicycle shown in FIG. 1, in a side view;

FIG. 3B is a schematic view of the frontal steering part of the foldable bicycle shown in FIG. 1, in an elevated view;

FIG. 3C is a schematic view of the frontal steering part of the foldable bicycle shown in FIG. 1, in an isometric view;

FIG. 4A is a schematic view of the seat support part of the foldable bicycle shown in FIG. 1, in a side view;

FIG. 4B is a schematic view of the seat support part of the foldable bicycle shown in FIG. 1, in an elevated view;

FIG. 4C is a schematic view of the seat support part of the foldable bicycle shown in FIG. 1, in an isometric view;

FIG. 5A is a schematic view of the rear frame part of the foldable bicycle shown in FIG. 1, in a side view;

FIG. 6 is an angular side view of the pivotal axis that joins together the three frame components of the bicycle;

FIG. 7 is a view of an intermediate stage of folding the foldable bicycle;

FIG. 8 is a view of the fully folded bicycle frame;

FIG. 9 illustrates another alternative embodiment of a foldable bicycle according to the present invention, with a shock absorber;

FIG. 10 illustrates yet another alternative embodiment of a foldable bicycle according to the present invention, with a shock absorber; and

FIG. 11 illustrates still another alternative embodiment of a foldable bicycle according to the present invention, with a shock absorber.

### DETAILED DESCRIPTION OF THE PREFERRED EMBODIMENTS

The present invention seeks to provide a foldable bicycle frame comprising three components: a frontal wheel steering component, a seat-support component and a rear, back-wheel, paddling component. The three components are hinged together by parallel and aligned rings mounted about a hollow tube-shaped cylinder axis. The components are held in a fixed and rigid position relatively to each other by a removable peg or screw that is inserted though the rings. With the peg or screw removed the free sliding circular movement of the rings around the cylinder axis provides the possibility of realignment of the three components in different angular positions, facilitating fixing the rings (provided more than one fixing position is provided) in other orientations, thus changing the fixture of the bicycle frame to suit the comfort of different users and different riding conditions. The single axis configuration allows for easy assembling for use and an easy folding procedure when required.

Various shock absorbent devices can be intergraded into the configuration of the rear, back-wheel, paddling component. Furthermore, the bicycle can be equipped with other cycling accessories (for example tachometer, brakes, lighting, gear mechanism).

A preferred embodiment in accordance with the present invention comprises a frame assembled of three components: a frontal steering component 20, a seat-support component 30 and a rear-paddling component 40. The three components are hinged together by a hollow tube-shaped cylinder axis 50.

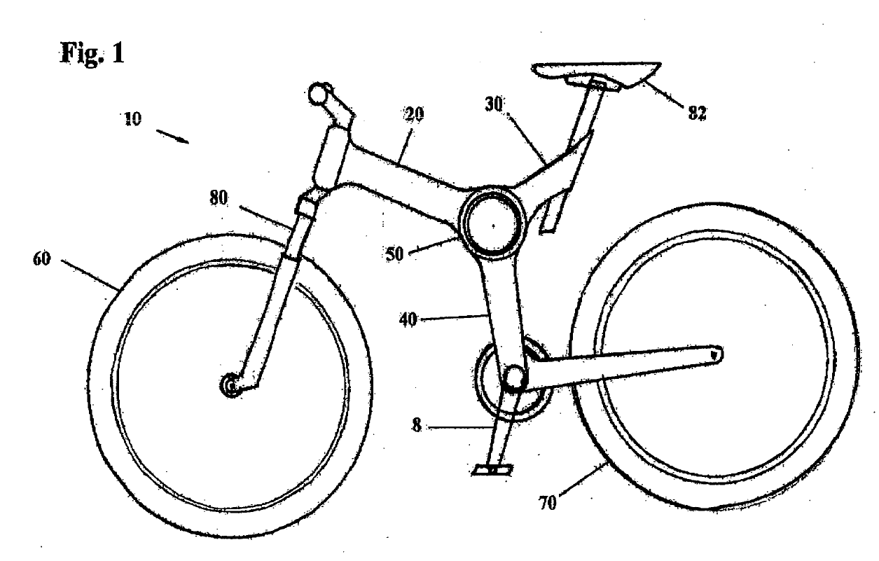

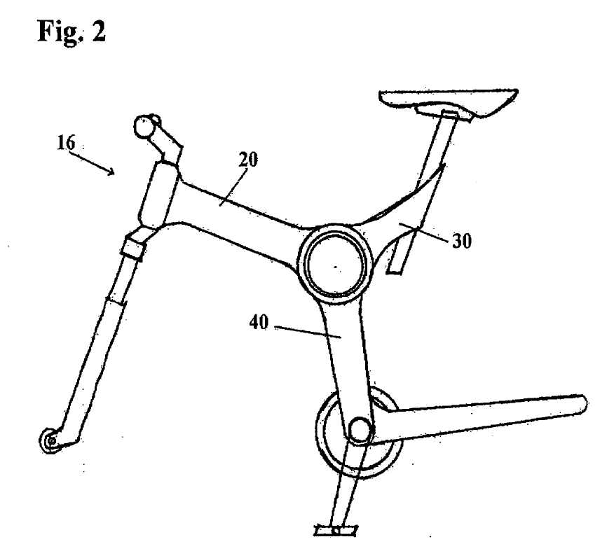

The three components and cylinder axis are viewed in FIG. 1 with the bicycle 10 assembled in a riding configuration and the front wheel 60 and back wheel 70 assembled. In FIG. 2 the bicycle frame 16 is viewed in a riding assembled configuration with the front and back wheels removed.

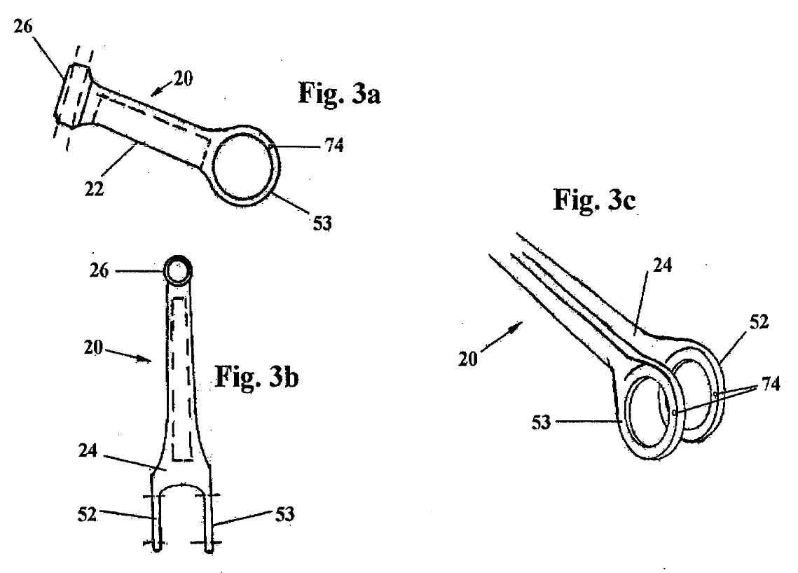

The frontal steering component 20 is composed of an elongated and forward aligned bar 22 ending at one end with an extended fork 24 comprising two substantially parallel and aligned rings 52 and 53, as illustrated in FIG. 3C, and a perpendicular tube 26 at the other, as illustrated in FIG. 3A and FIG. 3B. Through tube 26 runs fixture 80 that supports the front wheel 60 of the bicycle

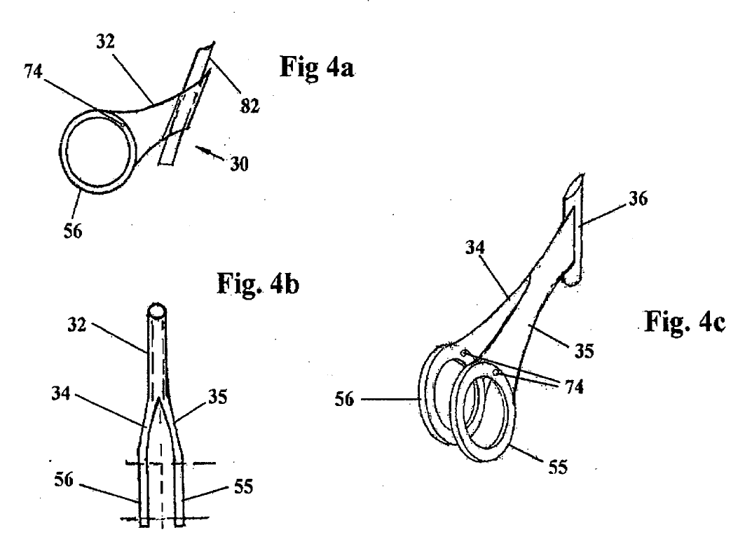

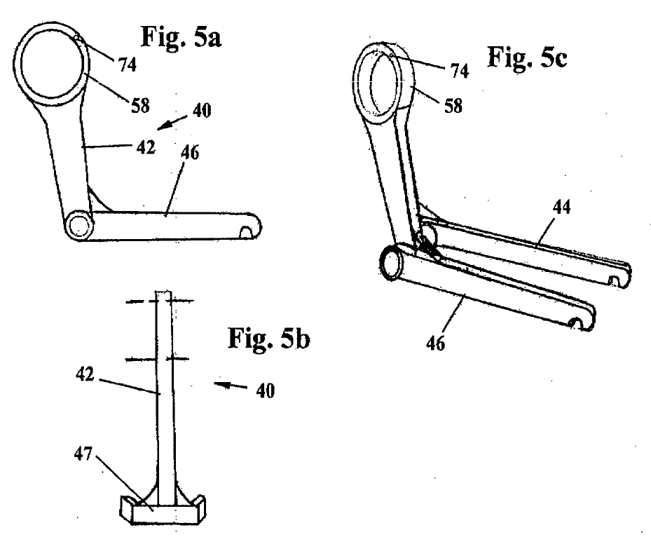

The seat-support component 30 is an elongated and forward aligned bar 32 with and an extended fork 34 and 35 of two parallel and aligned rings 55 and 56 at one end, as illustrated in FIG. 4B and FIG. 4C, and a short tilted tube 36 extending from the other end that receives the rod supporting the bicycle seat 82, as illustrated by FIG. 4A and FIG. 4C.

The rear paddling component 40 is composed of an elongated and aligned bar 42 with an extended aligned ring 58 at one end, illustrated in FIG. 4A and FIG. 4B, and two parallel bars 44 and 46 extending and protruding on either sides angled with respect to bar 42 and supporting the rear wheel 70 of the bicycle, as illustrated in FIG. 4B and FIG. 4C at the other end. The rods 44 and 46 are fixed in place and supported by a bridging slab 47 connected to bar 42, as illustrated in FIG. 4C. An integral part of the rear-paddling component 40 is a paddling mechanism 8 comprising a pair of driving paddles connected to a gear-wheel, a gear-wheel connected to the rear wheel 70 and a driving chain connecting between the two gear-wheels, as shown in FIG. 1 (these features are not shown in the figures for brevity and are considered a known and essential feature in every bicycle).

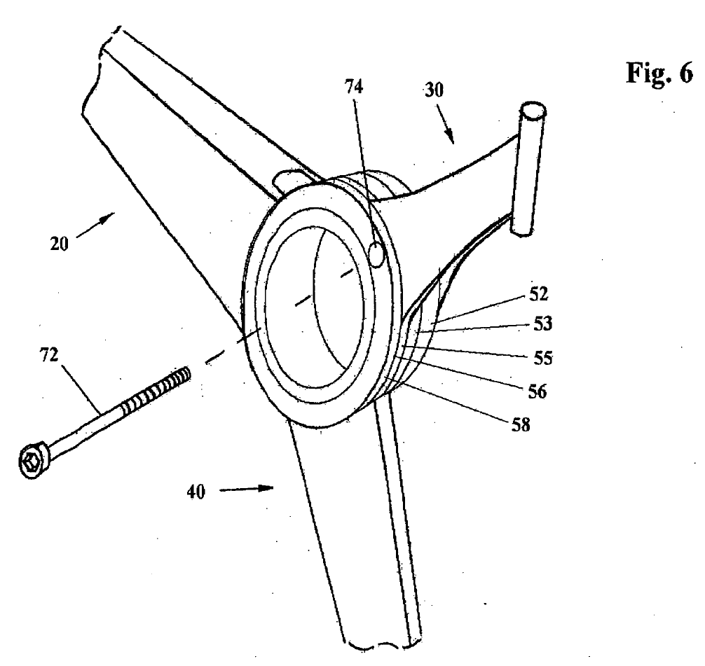

When the bicycle is in a riding configuration the three components 20, 30 and 40 are spaced apart and hinged around the hollow tube shaped cylinder axis 50 by orienting the aligned rings 52, 53, 55, 56 and 58 (of each of the three components), as illustrated in FIG. 6. The hollow tube shaped cylinder axis 50 is composed of a hallow cylinder 78 ending with a protruding ring 76. A peg 72 is inserted into a bore 74 and runs through the rings of the three components fixing the rings in a fixed position.

FIG. 6 illustrates one of several configurations in which the three components 20, 30, 40 can be secured and fixed together. Another configuration in which the placement of the three components will be in a different angular configuration, depending on the preference of the rider, can be achieved by providing additional bores on at least some of the rings for receiving peg 72 and inserting the peg through the preferred bores to obtain the desired orientation.

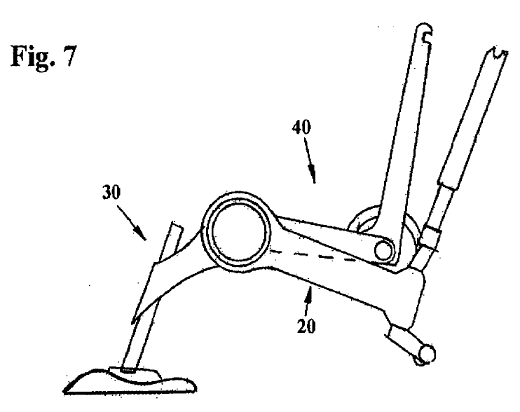

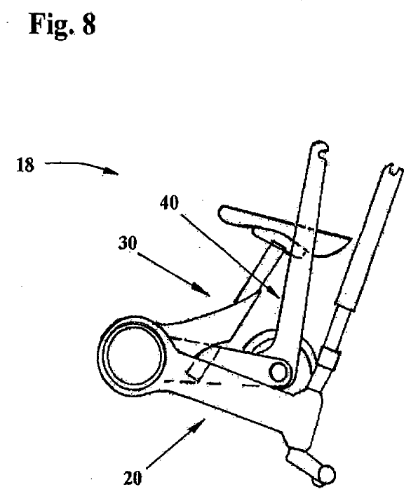

When the bicycle is to be folded the wheels 60 and 70 may be taken off, peg 72 is removed and three components 20, 30 and 40 are free to pivot around the hollow tube shaped cylinder axis 50 to assume a compact position. When the rear component 40 is pivoted as close as possible to the frontal component 20, as illustrated in FIG. 7, and the seat-support component 30 is pivoted as close a possible to the two previously compressed components, as illustrated in FIG. 8, the size of the bicycle frame in a riding configuration without the wheels 16 is very substantially compacted 18.

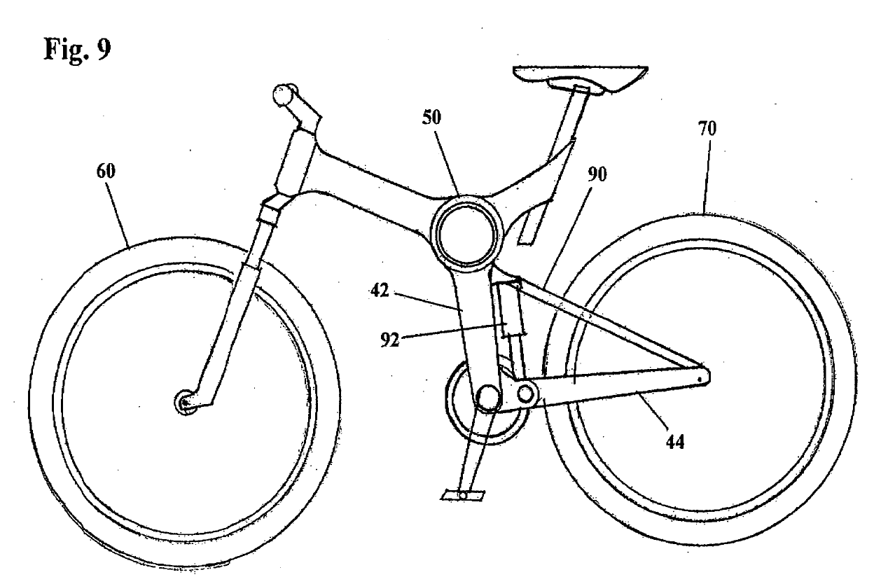

The rear component 40 can have alternative configurations. In FIG. 1 a basic configuration is illustrated. In FIG. 9 a stabilizing rod 90 is added to the rear component 40 by connecting between the upper part of the elongated bar 42, close to the cylinder hinge 50 (but not connected to that hinge), and the rear end of the wheel-supporting rod 44. A shock absorbing device 92 is placed between the wheel supporting rod 44 and the stabilizing rod 90.

In another configuration the three components 20, 30 and 40 each have only one aligned ring at one end. When the bicycle is in a riding configuration the three components 20, 30 and 40 are spaced apart and hinged around the hollow tube shaped cylinder axis 50 by orienting in parallel and fixing the three rings. In yet another alternative embodiment more than two rings are coupled to each component's bar. The rings themselves may be substituted with incomplete annular or arcuate fittings.

In another configuration the three parts of the foldable bicycle 20, 30 and 40 of the present invention pivot and are fixed in place relative to each other in accordance to the convenience of the rider by a pivotal axis other than a hollow tube-shaped cylinder axis.

In another configuration the design of each of the three main components of the folding bicycle 20, 30 and 40, is different than the design shown in FIG. 1 but still serves the same purpose: a steering component, a seat support component and a rear wheel paddling component.

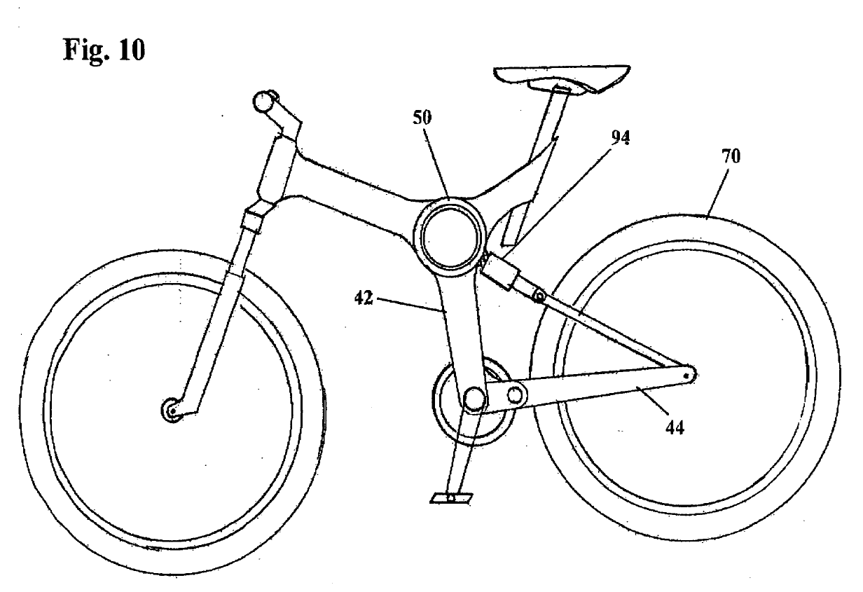

Another configuration for an addition of a shock absorbing device 94 to the rear component 40, is placing the shock absorbing device as an integral part of a rod connecting between the upper part of the elongated bar 42, close to the cylinder hinge 50, and the rear end of the wheel-supporting rod 44, as illustrated in FIG. 10.

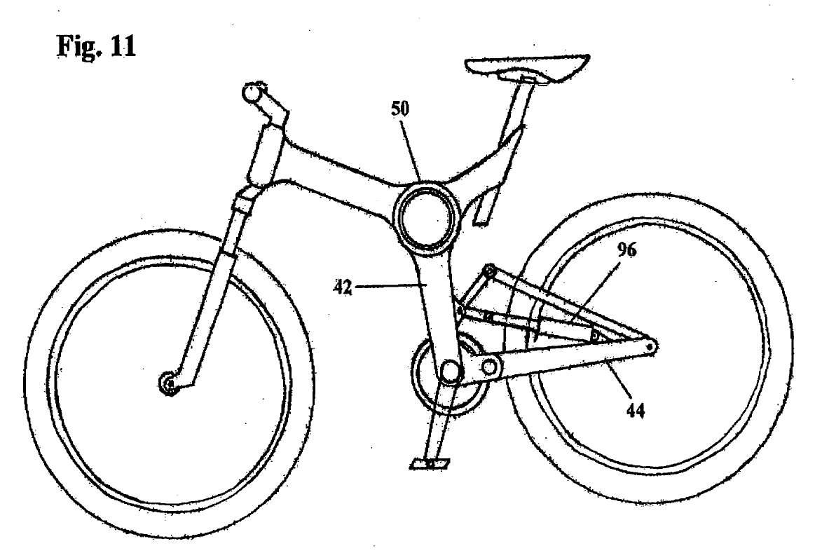

In FIG. 11 yet another alternative configuration a foldable bicycle with a shock absorber 96 is illustrated.

The novel design of the bicycle described herein renders the bicycle portable and easily foldable and reassembled. It is convenient to store the bicycle in the trunk of a vehicle and transport it to the location where it is desired to ride it, and assemble it there in a convenient and simple manner as illustrated hereinabove.

It should be clear that the description of the embodiments and attached Figures set forth in this specification serves only for a better understanding of the invention, without limiting its scope.

It should also be clear that a person skilled in the art, after reading the present specification could make adjustments or amendments to the attached Figures and above described embodiments that would still be covered by the present invention.

1. A foldable bicycle frame comprising:
a steering part comprising a first bar provided with at least one ring at a first end of the bar and a handlebar stem pivotally connected to the first bar at a second end for coupling to a front wheel;
a seat support part comprising a second bar provided with at least one ring at a first end of the bar and a adapted to be coupled to a seat at a second end;
a rear paddling part comprising a third bar provided with at least one ring at a first end of the bar and a adapted to be coupled to rear wheel;
a tubular cylinder connecting unit about which the rings of the first, second and third bars are pivotally mounted, wherein the rings may be aligned and fixed in at least one alignment.

2. The bicycle frame of claim 1, wherein at least one bore is provided on each ring and a matching peg is provided respectively, each said matching peg adapted to be inserted into each said bore, thereby fixing the rings in a predetermined alignment.

3. The bicycle frame of claim 1, wherein said at least one ring of each of the bars comprises a pair of rings.

4. The bicycle frame of claim 1, wherein at least one shock absorber is further provided to the rear paddling part.
